(19) United States
(12) Patent Application Publication
(10) Pub. No.: US 2002/0074789 A1
(43) Pub. Date: Jun. 20, 2002

(54) Motorized lap and shoulder safety belt system

(76) Inventor: Bruce H. Carraway JR., Atlanta, GA (US)

Correspondence Address: GARDNER GROFF, MEHRMAN & JOSEPHIC, P.C., Paper Mill Village, Building 23,Suite 300, 600 Village Trace, Marietta, GA, 30067, US

(21) Appl. No.: 09/870,333

(22) Filed: May 30, 2001

Related U.S. Application Data
(63) Continuation of application No. 09/739,056, filed on Dec. 14, 2000, now abandoned.

(51) Int. Cl. B60R 22/06

(52) U.S. Cl. 280/804; 280/801.1

(57) ABSTRACT

An automatically closing safety belt system for providing increased automobile safety. Safety belts are inside curved semi-rigid plastic sleeves, which hold safety belts out in front of the occupant. First configuration has lanyards attached to the middle of the safety belts. The other end goes into reels in dashboard. They pull the safety belts well out in front of the occupants until the belts' ends go operative. When the safety belts start going inoperative, the lanyards pull the safety belts and hold them near the dashboard for occupant easy egress and ingress. Second configuration is a gradual curve inward of the track. Third configuration is to put a hinge in the curved sleeve with a strong folding spring attachment, to be released by a switch. The reel between the seats can easily pull the lap belt into place. Fourth configuration, a motor and track under the vehicle seat moves a curved piece of metal or plastic that becomes attached to safety belts and automatically moves them into a restraining position. Fifth configuration includes a door track and a track located in a doorframe. The actuator configured to automatically close the restraining belt by moving the movable connector from the door track to the door post, when the door is closed and occupant seated. To leave, push a switch or turn off the ignition and the safety belts will move in the track to inoperative position.

### CROSS REFERENCE TO RELATED APPLICATIONS

This patent application relates to commonly-owned U.S. Pat. No. 5,709,408, issued on Jan. 20, 1998. This patent is herein incorporated by reference.

### TECHNICAL FIELD

The present invention relates generally to the field of vehicle safety belts. In particular, it relates to a motorized restraint system that provides both lap and shoulder restraint.

### BACKGROUND OF THE INVENTION

With the increase in types of automobiles, the frequency of automotive transportation has also increased. As the number of automobiles on the road multiplies, the concern for safety becomes greater. The National Highway Traffic Safety Administration reports that the current usage of manual lap belts and manual shoulder belts is about sixty-six percent (66%). In another report, this organization indicated that 91% to 97% of drivers accept and use motorized shoulder belts, when they are installed.

The provision of motorized safety belts for the lap and the shoulder is desirable in light of former President George Bush's 1992 safety belt program, which reported that 3,700 lives could be saved annually by getting seat belt usage from 60% up to 70%. Thus, adding a motorized lap belt to a motorized shoulder belt should help increase current safety belt usage of 66% up to approximately 91% to 97%, which represents an increase of about 38% to 47%. With such an increase, about 9,000 lives a year may be saved and, eight times that many or, 72,000 serious injuries may be prevented annually.

Prior art patents in the motorized safety belt field include U.S. Pat. No. 3,830,518, granted to Silber. Silber discloses a motorized bi-level safety belt with an attachment end that travels in a rail along a vehicle ceiling in a circular route to circumvent the body of a person on a seat in the vehicle. The rail extends down a doorpost of the vehicle to a low seat-level position for a lap belt and to a separate higher shoulder position for a shoulder belt. However, the ceiling positioning, in this patent, creates several problems including using sunroofs and obstructing vision. In addition, the proximity of the belts obstruct the steering wheel. Similarly, U.S. Pat. No. 5,183,291 granted to Shah discloses, in one embodiment, a shoulder belt track and a lap belt means that are positioned in a ceiling. Like Silber, this patent does not supply a feasible lap and shoulder belt restraint system and creates other safety hazards.

U.S. Pat. No. 4,313,622 granted to Suzuki et al. discloses a thick belt for holding an attachment end of a motorized shoulder belt. The belt travels in a rail from a front doorpost to a rear doorpost and then travels part way down the rear doorpost to shoulder level. However, the patent to Suzuki does not provide for lap restraint.

Despite the development in the area of motorized safety belts, conventional solutions fail to provide a feasible automatically closing seatbelt that minimizes obstruction to the user. Thus a need still exists for a feasible automatically closing seatbelt system.

### SUMMARY OF THE INVENTION

The present invention meets the needs described above in an automatically closing seatbelt system that enhances the space between a seatbelt and the occupant of a vehicle when the seatbelt is being closed. By enhancing this space, the present invention minimizes obstructions created by using this seatbelt system. When an occupant sits on a seat, the present invention automatically restrains the occupant without creating a substantial annoyance. The invention utilizes a spacing device that enhances the space between the occupant and the seatbelt as the seatbelt begins to close. Reducing user annoyance can increase use of the present invention, which improves vehicle safety.

Generally described, the automatically closing seatbelt system includes a spacing device configured to enhance a space between a seat belt and an occupant of the vehicle during an initial portion of a closing motion of the seat belt.

In one arrangement, the invention includes a restraining belt connected to a fixed anchor at a first end and connected to a movable connector at a second end; a track slidably constraining the movable connector; and an actuator for automatically sliding the movable connector along the track during the closing motion to close the restraining belt around an occupant located in the seat. In this arrangement, the spacing device may include first and second sleeves surrounding the restraining belt and located proximate to the movable connector or the fixed anchor. The spacing device may also include a hinge connecting the sleeves and a spring that biases the hinge toward an open position. The hinge may be configured to close against the bias of the spring as the restraining belt tightens under the force of the actuator.

In a second arrangement, the invention may include a restraining belt connected to a fixed anchor at a first end and connected to a movable connector at a second end; a track slidably constraining the movable connector; and an actuator for automatically sliding the movable connector along the track during the closing motion to close the restraining belt around an occupant located in the seat. In this arrangement, the spacing device may include a belt connector having a first end coupled to a middle portion of the restraining belt and a second end coupled to the actuator near the middle of the dashboard. The belt connector may be movable to facilitate adjustment of the space between the seat belt and the occupant when acted upon by the actuator during the closing motion.

In a third configuration, the invention may include a restraining belt connected to a first fixed anchor at a first end and connected to a movable connector at a second end and a buckle connected to a second fixed anchor proximate the seat. This buckle may be operative to receive the movable connector during a portion of the closing motion. In this arrangement, the spacing device may include a curved sheath connected to the movable connector at a first end and extending under the seat at a second end. The spacing device may also include an actuator for automatically closing the seatbelt by pivoting the movable connector until it couples to the buckle during the closing motion.

In a fourth arrangement, the invention may include a door located on the vehicle and movable from an open position to a closed position; a restraining belt connected to a fixed anchor at a first end and a movable connector in the door at a second end; and an actuator for automatically moving the movable connector during the closing motion to close the restraining belt around an occupant located in the seat. The spacing device may include a door track extending from a forward position located in the door to a rear position in the door. This door track may be positioned proximate the seat and operative slidably constrain the movable connector. The spacing device may also include a frame track located in a door frame and positioned adjacent the rear position of the door when the door is in the closed position. The actuator may be configured to automatically close the restraining belt by moving the movable connector from the door track to the frame track when the door is in the closed position and the occupant is in the seat.

In view of the foregoing, it will be appreciated that the automatically closing seatbelt system improves over the drawbacks of prior systems. The specific techniques and structures employed by the invention to improve over the drawbacks of the prior systems and accomplish the advantages described above will become apparent from the following detailed description of the embodiments of the invention and the appended drawings and claims.

### BRIEF DESCRIPTION OF THE DRAWINGS

FIG. 1 is a side view of a doorway section that can be used with a first embodiment of an automatically closing seatbelt system.

FIGS. 2-3 are enlarged views of the movable connector illustrated in FIG. 1.

FIG. 4 is an enlarged view of a track showing a variable stop in relation to the system of FIG. 1.

FIG. 5 is an enlarged, schematic view of a portion of the track of FIG. 4 along a portion of section A-A without the variable stop present.

FIG. 6 is a planar view of a first embodiment of an automatically closing seatbelt system according to the present invention. A spring and hinge combination enables relative movement of the sleeve.

FIG. 7 is a schematic view of a doorway section and a seat of a vehicle as viewed in FIG. 1. But, added to that, is a detailed view of a small rope or belt attached to safety belts on one end, to the reel in the dashboard on the other end and holding the safety belts well out in front of a vehicle occupant in a preferred embodiment according to the present invention.

FIG. 8 schematically illustrates motorized bi-level safety belts, which when going into a restraining position, are connected to a hard plastic or metal curved sheath coming from under the vehicle seat to move the ends of the safety belts automatically out and away from the body of a vehicle seat occupant into a restraining position, and then return automatically to their position under the seat.

FIG. 9 is a view similar to FIG. 8 showing a modified arrangement with the raised edges of the curved hard plastic or metal holding the lap belt between the raised edges on top of the curved rigid piece.

FIG. 10 is a view similar to FIG. 8 showing a modified arrangement with a curved hard plastic or metal piece or it could be a bar moving the ends of the safety belts, but, dragging the rest of the lap belt below the level of the front end of the safety belts and out of the retractor near the door.

FIG. 11 is a schematic side view of a vehicle door with bi-level safety belts driven by the rods connected to the door hinges and then moved by solenoids into, and later, out of the doorpost.

FIG. 12 is a view similar to FIG. 11 except that the shoulder belt moves in a slot just below the area of glass in the door and both safety belts are driven only by solenoids to the doorpost for an operative position and, then later, driven by solenoids to an inoperative position on the door.

FIG. 13 is a view similar to FIG. 11 for the shoulder belt except it is moved by solenoid power only. It is similar to FIG. 12 for the lap belt except its starting inoperative position is up higher on the door but still moved by solenoids only.

### DETAILED DESCRIPTION OF THE EMBODIMENTS

The present invention may be embodied in an automatically closing seatbelt system for a vehicle that reduces annoyance by using a spacing device. When not in use, the seatbelt system remains in a non-operative position. In this position, occupants of the vehicle remain unrestrained to one of the vehicle's seats. For example, the present invention may remain non-operative as an occupant sits on the seat in the vehicle with the door open. Thus, the occupant may freely move about the vehicle without obstruction from the present invention.

If an occupant completes an activation action, the automatically closing seatbelt system may complete a closing motion that closes the seatbelt around an occupant located in a seat. For example, an occupant may close the door or put a key in the ignition. Either of these actions may activate the present invention and result in a closing action. As the closing motion begins, the spacing device enhances the space between the seat belt and the vehicle occupant. This space enhancement is explained later with reference to particular embodiments.

In a first embodiment, the automatically closing seatbelt system includes a restraining belt, fixed anchor, movable connector, and track. A seat belt may include one or more restraining belts. Together, these devices close the restraining belt around an occupant located in the seat. For this embodiment, the spacing device includes sleeves that surround the restraining belt. A spring and hinge combination enables relative movement of the sleeves. When acted upon by the actuator, the hinge closes against the bias of the spring. This motion positions the sleeves in a bent position that aides in securing an occupant to the vehicle's seat.

During a closing motion, the end of the restraining belt connected to the movable connector slides along the track to a belt operative position. When the belt reaches this position, the actuator tightens the end of the restraining belt connected to the fixed anchor. This tightening bends the sleeves and effectively secures the occupant to the seat. The spacing device enhances space by using rigid sleeves and a hinged biased to an open position. This combination minimizes obstructions that could annoy the seat occupant during a closing motion. As a variation, the track may twist during the closing motion to cause the lap belt sleeve to turn toward the vehicle occupant.

In another alternative embodiment, the spacing device may include a belt connector attached to the dashboard, for example. The belt connector may pull the restraining belt away from the occupant before the closing motion. During the closing motion, the belt connector reduces the tension applied to the restraining belt. In response, the restraining belt moves towards the occupant. Consequently, the belt connector facilitates adjustment of the space between the occupant and the restraining belt.

The automatically closing seat belt system of an additional embodiment includes a restraining belt, fixed anchor, movable connector, actuator, and a curved sheath. During the closing motion, the actuator pivots the curved sheath towards the buckle. As the buckle encounters the movable connector end of the curved sheath, the system automatically closes the seatbelt around the occupant. The rigidity of the curved sheath helps maintain a fixed distance between the sheath and the occupant during the closing motion.

In a final embodiment, the automatically closing seat belt may include a door, restraining belt and actuator. The spacing device may include a door track and frame track. As the door closes, one end of the door track is positioned proximate the frame track. In response, the movable connector slides from an unlock position in the door track to a lock position inside the doorpost. As the movable connector reaches the lock position in the doorpost, the present invention secures the seatbelt around the occupant.

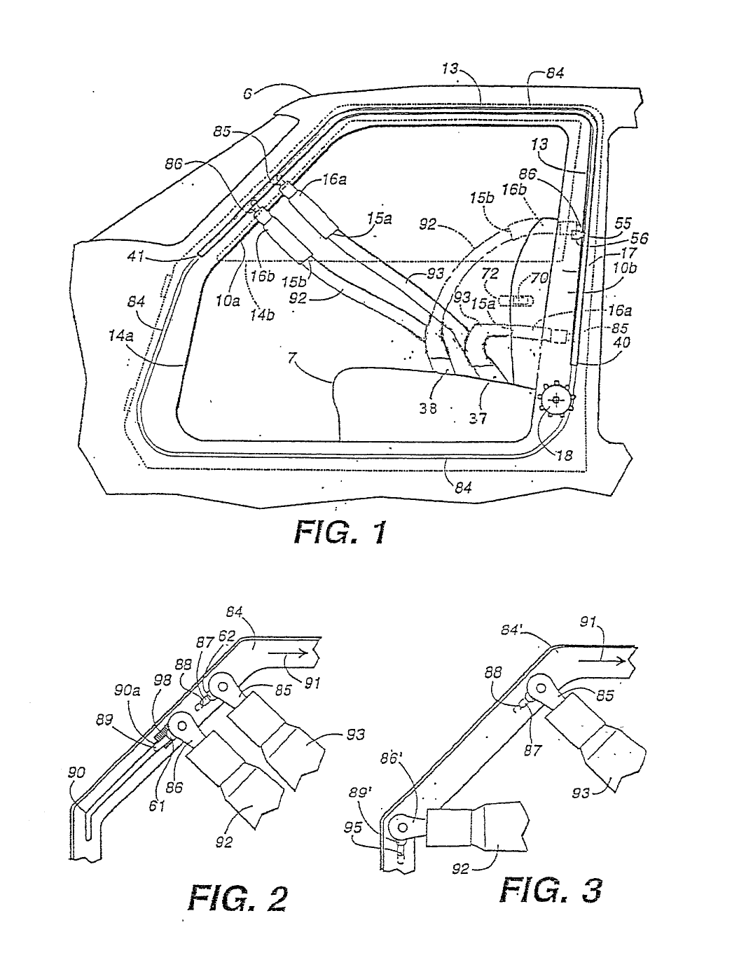

Reference is now made to the drawings, and those embodiments of the invention here presented by way of illustration, wherein like reference numerals designate corresponding parts throughout the several figures. FIG. 1 depicts a front seat 7 (although it could just as well be a rear or other seat) of a vehicle 6 with a restraint system shown according to the present invention as viewed from outside the vehicle 6. A driver's side doorway 14a is shown in the vehicle 6, with the seat 7 therein. Note that a door 14b is understood to be associated with the doorway 14a although the door 14b is not specifically schematically shown in any of the drawings. Extending partially around the doorway 14a is a stationary track 13. Adjacent to the track 13, but circumscribing the doorway 14a, is a drive belt or conveyer 84. The drive belt or conveyer 84 is driven by a sprocket 18, which can be rotated by an electric motor 104 (not shown in FIG. 1), hydraulic motor, or, other means as is well known to those skilled in the art.

In the restraint system, a shoulder belt 92 and a lap belt 93 have inoperative positions, wherein a movable end (finger) 89 of the shoulder belt 92 and a movable end (finger) 87 of the lap belt 93 are located at forward portion 10a of doorway 14a as shown in FIGS. 1 and 2. When the vehicle ignition is turned on, the sprocket 18 is caused to rotate clockwise (in the perspective of FIG. 1), thereby driving the drive belt 84 and the moving ends 87 and 89 to their respective body-restraining or operative positions, toward the rearward portion 10b of the doorway 14a. In FIG. 2, the motorized lap belt 93 rides in the track 13 (not shown in FIG. 2) along with the shoulder belt 92 and may be positioned adjacent to motorized shoulder belt 92 when in the inoperative position (see FIG. 2), or, alternatively, be positioned across the lap of the driver in the operative position (not shown in FIG. 2).

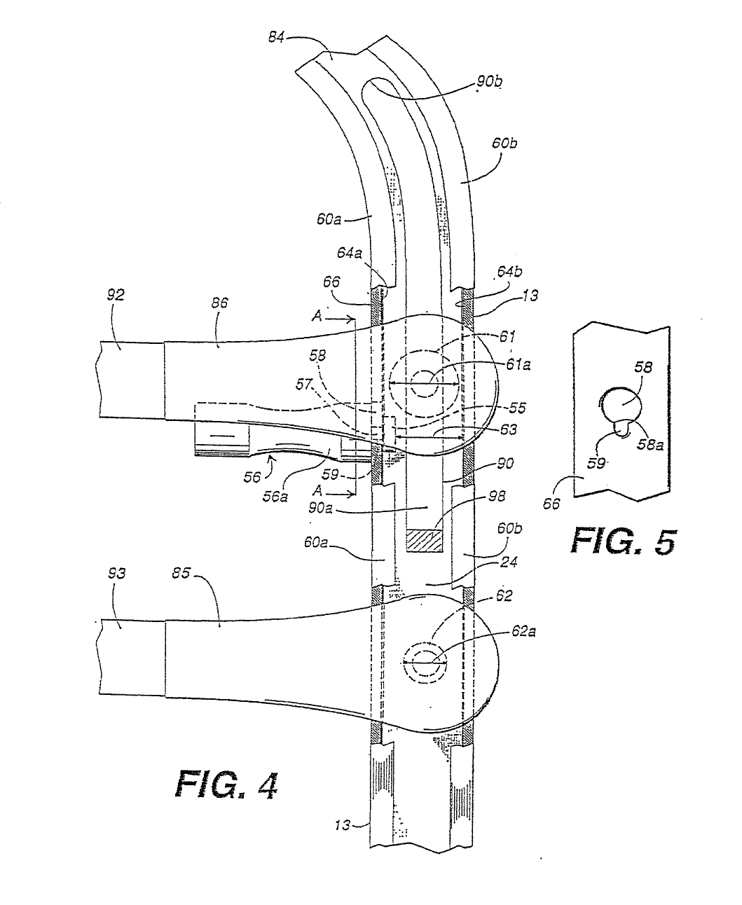

In conjunction with FIG. 1, looking now at FIG. 2, which shows a non-restraining or inoperative position of one embodiment of the present invention as viewed from inside the vehicle 6, drive belt 84 is shown in attached or engaged association with the connectors 85 and 86 on lap belt 93 and shoulder belt 92, respectively. Note that although track 13 is not shown in FIG. 2, it is to be understood that a portion of the length of the drive belt 84 moves within the track 13 over the total length of the track 13 in accordance with the present invention (see FIG. 4). In one embodiment of the present invention, drive belt 84 has connectors 85 and 86, which are trammeled by track or rail 13 (not shown in FIG. 2). In this embodiment, connector 85 has finger or metal nose 87 attached thereto which engages drive belt 84 in hole 88. On the other hand, connector 86 has finger or metal nose 89 attached thereto which is engaged and apprehended by catch 98 located at the end of slot 90 proximate to hole 88 in drive belt 84. In a preferred embodiment according to the present invention, catch 98 is a magnetic catch, i.e., catch 98 may be a magnet or include magnetic material, which magnetically attracts, engages or holds finger 89. A magnetic catch 98 could be made of an appropriate magnetic material, appropriately shaped to best attract and magnetically hold or apprehend finger 89 according to the shape of magnetic catch 98. Although a magnetic catch is a preferred embodiment, it should be understood that other embodiments such as a hook, a clasp, or other type of catch would also work according to the present invention. Therefore, that catch 98 which is magnetic should not be viewed to overly limit the scope of the present invention.

With the above described arrangement, it will be understood that when the drive belt 84 is driven in the direction of the arrow 91, both shoulder belt 92 and lap belt 93 will be moved from their respective inoperative positions around track 13 toward the rearward portion 10b of doorway 14a, to doorpost 17 of vehicle 6. As drive belt 84 moves, both connectors 85 and 86 of lap belt 93 and shoulder belt 92, respectively, will move along track 13. Connector 85 of lap belt 93 will move until it reaches its terminating operative position proximate the rearward end 40 of track 13, proximate the seat cushion level of vehicle seat 7, wherein the lap belt 93 will be in a restraining or operative position across the lap of the occupant of vehicle seat 7.

Although connector 86 of shoulder belt 92 will move with drive belt 84, its motion requires further detail as will be discussed now. To wit, in the inoperative position, finger 89 of connector 86 is engaged and apprehended by catch 98. As drive belt 84 begins to move to the operative position, for instance, when the ignition of vehicle 6 is turned on, the finger 89 of connector 86 will be moved by belt 84, and thereby also move shoulder belt 92 as described. Connector 86 of shoulder belt 92 moves because it is apprehended by catch 98 at the rearward end 90a of slot 90. Drive belt 84 thereby moves belt 92 because of the engagement of catch 98 with connector 86. When connector 86 of shoulder belt 92 reaches the shoulder position (shown in dashed lines in FIG. 1) as connector 86 is being moved by drive belt 84, the finger 89 of connector 86 will encounter or strike belt stop 55 (see FIGS. 1 and 4) of track 13 so that shoulder belt 92 will stop in a restraining or operative position across the shoulder of the occupant of vehicle seat 7, wherein finger 89 is disengaged or released from catch 98 and slot 90 continues now to move past finger 89 until drive belt 84 stops with lap belt 93 in an operative position, and thus, the forward end 90b of slot 90 is proximate the finger 89 and prevents movement of connector 86 back toward the inoperative position as will be described below. Also, in a preferred embodiment according to the present invention, and as schematically illustrated in FIG. 4, stop 55 is a circular stop pin, which will also be described in more detail below.

When the occupant is ready to exit from vehicle 6, sprocket 18 will be driven in a reverse direction to the direction of motion described above, causing drive belt 84 to move in the opposite direction to that just described. Connectors 85 and 86 will therefore be moved from respective restraining positions at the rear 10b of the doorway, which is shown in broken lines in FIG. 1, to the releasing or inoperative position at the forward portion 10a of the doorway 14a, which is shown in full lines in FIG. 1. Connector 85 will, of course, be moved immediately with drive belt 84 since it is fixedly connected to drive belt 84 by nose 87. Connector 86, however, will be delayed in moving, because of the length of slot 90 which must first pass by finger 89. As belt 84 continues to move along track 13, slot 90 will eventually have moved far enough for finger 89 of connector 86 to again be apprehended by catch 98. Then connectors 85 and 86 can move together a fixed distance apart again, e.g., approximately 1 to 2 inches or so apart in the preferred embodiment, because catch 98 is positioned at the end of slot 90 approximately 1 to 2 inches or so from hole 88 where nose 87 is connected.

As has been described above, in moving to its operative position, connector 86 is stopped as it engages belt stop 55, which exerts enough mechanical force to overcome the force of engagement (magnetic or otherwise) between finger 89 and catch 98. This mechanical interaction causes catch 98 to pull away from finger 89 of connector 86, leaving the vehicle seat occupant secured by shoulder belt 92 with connector 86 in its operative position at stop 55. On the other hand, for the vehicle seat occupant to be released from the restraint system, shoulder belt connector 86 will again be apprehended by catch 98 for motion of belt 84 toward the inoperative (retracted) position at the forward portion 10a of doorway 14a. Shoulder belt connector 86 and lap belt connector 85 will be positioned together in their respective inoperative positions because of catch 98 at the end of slot 90 in drive belt 84 which is proximate hole 88. Connector 86 will remain apprehended by catch 98 and spaced a fixed distance from connector 85 until these connectors and the lap 93 and shoulder 92 belts move to their operative positions, whereupon stop 55 separates connector 86 again from catch 98 upon activation of the vehicle restraint system.

Attention is next directed to FIG. 3 in conjunction with FIG. 1 of the drawings. FIG. 3 schematically presents an alternative embodiment in accordance with the present invention, wherein connectors 85 and 86′ are fixedly spaced away from each other along drive belt 84′ by several inches. In the preferred embodiment, the fixed spacing is approximately 24 to 30 inches. Note that FIG. 3 is similar to FIG. 2, except that finger 89′ extends instead into single hole 95 defined in belt 84′ rather than a slot such as slot 90 of FIG. 2. With the use of holes 95 and 88, both connectors 85 and 86′ , and hence both belts 93 and 92, will move as soon as drive belt 84′ moves in the direction of (toward operative positions), or opposite to the direction of (toward inoperative positions), arrow 91 as depicted in FIG. 3. In accordance with the initial spacing of connectors 85 and 86′, belts 93 and 92 will move into their restraint or operative positions while the spacing is maintained between connects 85 and 86′. Upon retraction towards the forward end 41 of track 13, i.e., towards their inoperative positions, belts 93 and 92 will move simultaneously, again maintaining their separation and the fixed separation of connectors 85 and 86′.

Referring again to the above embodiments in accordance with the present invention as shown in FIGS. 2 and 4, a fixed stop 55 stops the movement of shoulder belt 92 in its operative position while slot 90 continues to move past finger 89 until lap belt 93 reaches its own operative position. It will be understood, however, that people vary in size, and that different people may require or prefer dissimilar position heights for shoulder belt 92 in the operative position. Therefore, to provide some variation in the operative height position of shoulder belt 92 as will be described in more detail below, the arrangement schematically illustrated in FIGS. 4 and 5 may instead be used. Note that the length of the slot 90 is greater than or equal to the maximum distance the belt 84 moves from the uppermost position of the stop 55, which can stop shoulder belt 92 in it highest position, to the operative position in which the drive belt 84 (the lap belt 93) stops.

Referring now to FIG. 4 which is a schematic representation of a portion of track 13 in another preferred embodiment in accordance with the present invention, it is observed that track 13 includes a channel 24 having overlying flanges 60a and 60b at each side thereof. In order to guide belts 92 and 93 respectively, followers 61 and 62 (forming parts of connectors 86 and 85, respectively) are coupled to belt 84 and disposed within channel 24, being held therein by flanges 60a and 60b of rail 13. Follower 61 is larger (e.g., larger diameter 61a) than follower 62 (e.g., smaller diameter 62a) to allow connector 86 of shoulder belt 92 to be stopped by stop 55 in the operative position, whereas connector 85 of lap belt 93 will not be stopped by, but will instead pass by, stop 55 in its motion toward the operative position for lap belt 93. Note that FIG. 4 does not specifically show finger 89 and nose 87 (both of which would project into the page of FIG. 4), and hole 88, although it is to be assumed that they are present as parts of connector 86, connector 85, and defined by drive belt 84, respectively. However, FIG. 4 does schematically illustrate slot 90 and catch 98.

Track 13 defines a plurality of holes 58 in wall 64a of track 13, each one of the plurality of holes 58 being adapted to receive a stop member generally designated as 56 in FIG. 4. Although only one hole is shown in FIG. 4, it is to be understood that the plurality of holes 58 are located in the interior metal strip 66 of the track 13 in fixed spatial relation to each other (e.g., each adjacent hole of the plurality of holes 58 being approximately one inch apart) in track 13 to allow easy adjustment of the height at which connector 86 is stopped by stop 55. Examination of FIG. 4 reveals that follower 61 is of such large size that it cannot pass by stop 55 which forms part of stop member 56 and is attached thereto by neck 57. Follower 61 cannot pass by stop 55 because its size (diameter 61a) is generally larger than the spacing between stop 55 and wall 64b of track 13, which is generally designated as spacing 63 in FIG. 4. The result of stopping follower 61 and connector 86 is that shoulder belt 92 will also stop generally where stop member 56 is in place as discussed above. On the other hand, follower 62 of lap belt 93 is of smaller (diameter 62a) size than follower 61 (diameter 61a) such that follower 62 can pass through spacing 63 and pass by stop 55 within channel 24 of track 13 even though stop member 56 is in place. Follower 62 will, therefore, pass by both stop member 56 and attached stop 55, and continue to move until the restraining or operative position of lap belt 93 is reached.

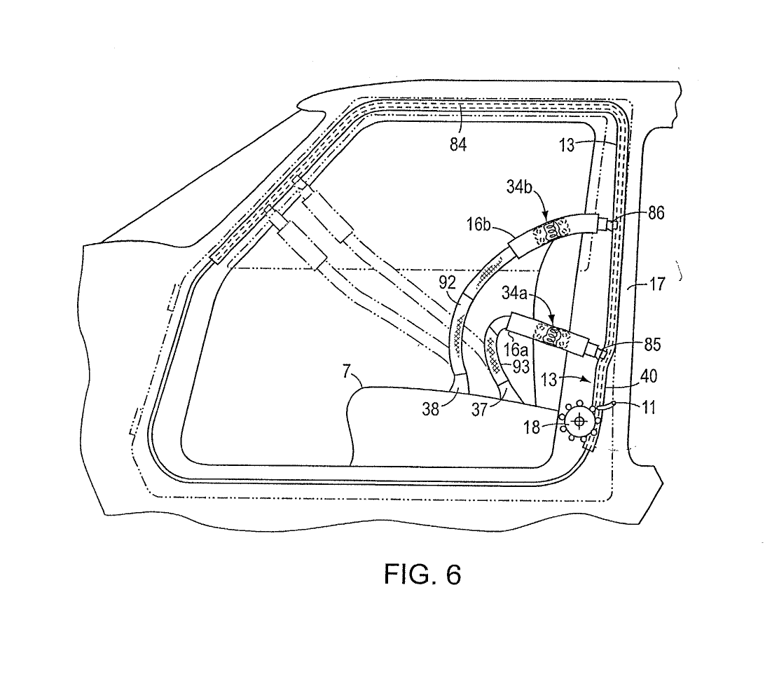

Those skilled in the art will readily devise numerous arrangements to fix stop member 56 in place on track 13. Therefore, the simple and effective arrangement that is schematically shown in FIGS. 4 and 5 should not be considered a limiting arrangement or embodiment regarding the scope of the present invention. However, referring to the particular embodiment schematically illustrated in FIG. 5, holes 58 are schematically depicted in the general shape of keyholes. Stop member 56 includes stop 55 handle portion 56a and neck 57 as already discussed, wherein neck 57 has a dimension generally smaller than stop 55. Thus, stop 55 is smaller than, and can be inserted into, the larger portion of hole 58 schematically shown in FIG. 5, and then stop member 56 can be moved down from the point of view shown in FIG. 5 so that neck 57 is received by smaller portion 59 of hole 58, which is apparent from the views depicted in FIGS. 4 and 5 taken in conjunction. Stop member 56 may now also be locked in position by the combined action of a retractor 27 (shown in FIGS. 6a and 6b, but not in FIG. 1) of belt 92 which retracts or pulls an end 12b (FIG. 1, 6a, and 6b) of belt 92 closest to retractor 27 with stop 55 positioned in smaller portion 59 of one hole of the plurality of holes 58 and being brought to bear against the edge 58a thereof by the retraction of belt 92 or by any other means known to one of ordinary skill in the art. Handle portion 56a of stop member 56 having generally a larger size than hole 58, as is apparent from FIG. 4, will prevent movement of stop member 56 inward toward track 13, while stop 55, also having generally a larger size than hole 58, will prevent outward movement of stop member 56 away from track 13 thereby substantially holding stop member 56 in place on track 13.

Another embodiment involves the positioning of the lap belt. To be sure that the lap belt 93 is well accepted by the vehicle occupant, it needs to move from being held out in front of the occupant's body, to being easily pulled into place.

To accomplish this, FIG. 6 shows the lap belt 93 is inside a semi-rigid plastic sleeve 16a with about a 45° to 90° curve in it. The curve does not begin until about 4 to 10 inches out from the lap belt end 85 or connector 85 located in the track 13. This semi-rigid plastic sleeve 16a has soft edges and is about 20 inches long, more or less.

The curved sleeve 16a area nearest the doorway is pointed toward the bottom of the door 14a and then toward the dashboard as it moves down the doorframe 14a. Then it will not come too close to the occupant's head as it passes it.

This semi-rigid curved sleeve 16a covers the lap belt 93 for about 20 inches, right up to and including its attachment or connector 85 to the track 13. However, in a preferred embodiment according to the present invention, is to have the track 13 that the end 85 of the lap belt 93 moves in down the vehicle's doorpost 17 to be turned or twisted gradually inward toward the middle of the vehicle seat 7 and the vehicle occupant's lap, several inches just before the end, or connector 85, of the lap belt 93 reaches the restraining position 40 in the track 13. Thus the lap belt 93 within the curved semi-rigid sleeve 16a is turned inward by the track 13 just as the retractor reel 37 in the middle of the seat 7 is pulling it in place. This means the lap belt 93 goes easily from being held out in front of the vehicle occupant, to being pulled into a restraining position 40 without it being objectionable in its movement to the occupant.

Another embodiment, also illustrated in FIG. 6, is to have a hinge with a strong folding spring attachment 34a, 34b in the roughly 45 to 90° degree curved semi-rigid plastic sleeve 16a, 16b about 20 inches long more or less, with the curved area not beginning until 4 to 10 inches out from the track 13 and the lap and shoulder belt ends 85, 86. This curved plastic sleeve 16a, 16b, part nearest the door is pointed toward the bottom of the door 14a as it moves along the top of the door. Then the ends or connectors 85, 86 of the belts 92, 93 and upper part of the sleeve 16a, 16b, start down the doorpost and this causes the curved plastic sleeves 16a, 16b to point toward the dashboard, therefore, in neither instance will the plastic sleeves 16a, 16b pass too close to the occupant's head as it passes by it.

Another embodiment, as shown in FIG. 6, is that these strong folding spring attachments 34a, 34b in the plastic sleeves 16a, 16b are released when the lap belt end 85 reaches the restraining position 40 in the track 13 and trips a switch 11 there. This release of the strong springs 34a, 34b, which keeps the plastic sleeves 16a, 16b rigid, causes the curved plastic sleeves 16a, 16b to bend toward the middle of the seat 7 and allows the retractor reels 37 38 in the middle of the seat 7 to easily pull over the belts 92, 93 in the curved, semi-rigid sleeves 16a, 16b. Then, the belts 92, 93 are no longer held out in front of the vehicle occupant's body because, the between the seats reels or retractors 37, 38, have pulled the belts 92, 93 into a proper restraining position across the vehicle occupant.

In another embodiment, in accordance with the present invention, we have a hinge with a strong folding springs 34a, 34b, attached within a straight semi-rigid plastic sleeve about 20 inches long. We have this hinged spring 34a, 34b, just like the one shown in my U.S. Pat. No. 5,709,408, except for the following difference: that hinged spring is attached to a curved semi-rigid plastic sleeve near the middle of the seat whereas our new embodiment has it attached in the straight or curved plastic sleeve near the doorway, and this straight plastic sleeve is pointed down toward the bottom of the doorway which turns upward toward the dashboard as the ends 85, 86, of the lap and shoulder belts 92, 93, moves down the doorpost 17 so the plastic sleeves 16a, 16b will not come too close to the vehicle occupant's head as it passes it. These strong springs 34a, 34b will be released when the lap belt end or connector 85 reaches a restraining position 40 in the track 13 near the bottom of the doorpost 17 and flips a switch 11. Then, the reels or retractors 37 38, between the seats can more easily pull the lap and shoulder belt plastic sleeves 16a, 16b across and down to the occupant's lap because, with the hinged spring 34a, 34b released, the straight plastic sleeves 16a, 16b now bend and curve over toward the reels or retractors 37, 38, because the strong spring 34a, 34b, release allow the semi-rigid plastic 16a, 16b to now curve toward the middle of the seat 7. The strong folded spring attachment 34a, 34b, has a cover over it in all cases to protect it and to make the area smooth.

Then, when the ignition is turned on and a vehicle occupant wants to leave the vehicle, he must push a switch on the doorpost 17 or pull the door handle 72, which has a switch 78 attached to it and this occurs: The safety belts 92, 93, begin to move toward a non-restraining position 41 and immediately a switch 11 is flipped in the track 13 or in the track motor 18, which causes the strong folded spring attachment 34a, 34b, to become immediately rigid again and thus, the entire plastic sleeves 16a, 16b, are rigid again. This immediately helps to change the curved plastic sleeves 16a, 16b, back to being more curved or it begins to change the bent-over plastic sleeve back into a straight sleeve; both are near the door 14b. You could use either a curved or straight sleeve, either one would hold these safety belts 92 93, well out in front of the vehicle occupant, as it moves toward a non-restraining position.

Motorized shoulder 92 and lap 93 belts are moved to restraining positions by a drive belt 84 along a track 13 around a doorway of a vehicle. A magnetic catch 98 or other catch in the drive belt 84, or attached to the lap belt end in the drive belt track 13, engages the shoulder belt 92 to move with the lap belt 93 when the drive belt 84 moves the lap belt 93. An adjustable height stop 55 in the track 13 stops the shoulder belt 92 in its proper restraining position and disengages the shoulder belt 92 form the magnetic catch 98 while the lap belt 93 continues to move and stops in the lap belt restraining position 40. The safety belts 92, 93 come automatically across in front of the vehicle occupant and the shoulder belt 92 is well accepted, but the lap belt 93 to be more accepted, needs to be held out more in front of a person's body as it goes into place.

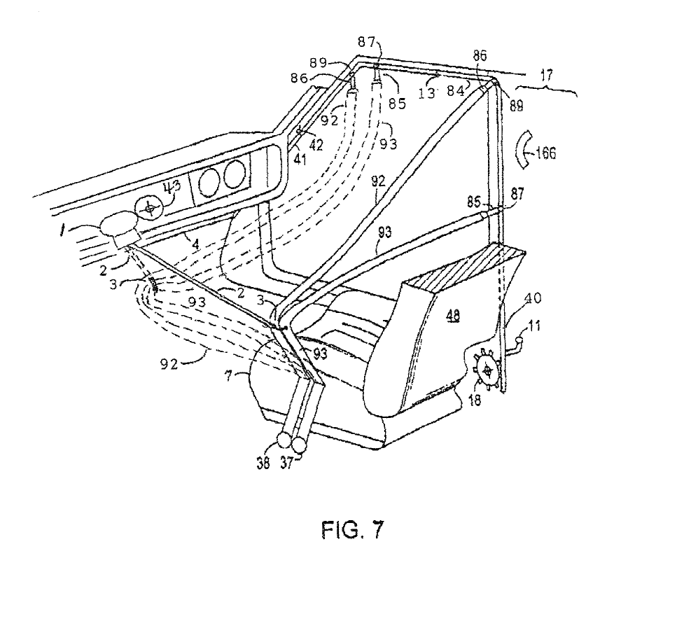

An alternative to the embodiment shown in FIG. 6 can be seen in FIG. 7. A small belt 2 or rope 2 is attached to the lap belt 93, and the same one with a connection 3 between them or a separate one attached to the shoulder belt 92. These belts 2 or ropes 2 and the connection 3, may have elasticity. These small belt(s) 2 or ropes 2 are attached to the safety belt's 92, 93 near the location where the safety belts go into the take-up reel(s) 37, 38, between the seats. The other ends of the small belt(s), or rope(s) would be attached to take-up reels in the dashboard 4 area, and near the middle of the vehicle. These reel(s) could be motor-operated. To get the safety belts 92, 93, into a restraining position around a vehicle occupant, the closing of the door 14a of the vehicle flips a switch 78. If the ignition is turned on and there is a person's weight in the seat 7, the following immediately happens: The small belt or rope reel(s) 1 or retractor(s) 1, releases the middle of the safety belt(s) 3 from next to the dashboard 4 at fast speed to return to a stop about fifteen inches out from the dashboard 4, and about fifteen inches in front of the vehicle occupant. Then, after about a five-second delay, the ends 85,86, of the shoulder 92 and lap 93 belts in the track 13, and, of course, the safety belts 92, 93 begin moving toward their restraining positions.

The vehicle occupants are very pleased with the way the safety belts 92, 93 are held well out in front of them. Then the end 85 of the lap belt 93 in the track 13 flips a switch as it reaches its restraining position 40. This immediately causes the reel(s) 1 in the dashboard to again release the pull on the small belt(s) 2 or rope(s) 2. Then, the safety belt reel(s) or retractor(s) 37, 38 in the middle of the seats will easily pull the loosened small belt(s) 1 or rope(s) 1 along with the safety belts 92, 93. Now the safety belts 92, 93, are no longer held out in front of the vehicle occupant and are pulled into the normal restraining position. The safety belt middle of the seats reel(s) or retractor(s) 37 and 38, could be angled or on a pivot, so they are sometimes angled toward the dashboard 4, and sometimes toward the seat occupant's lap. Then, the safety belts 93, 93 can be pulled equally as well by the small belt or rope reel(s) 1 in the dashboard 4 when they need to pull, or, by the safety reel(s) or retractor(s) 37, 38 between the seats, when they need to pull or release.

When the vehicle occupant wants to leave the vehicle, he can press a switch 166 on the doorpost 17, or pull the door handle 72 where switch 78 is located (if the ignition is turned off, this happens automatically). This activates the motor 43 for the reel(s) 1 or retractor(s) 1 in the dashboard, so that the small rope(s) 2 or belts(s) 2 will immediately pull the middle 3 of the safety belts 92, 93 out away from the vehicle occupant only about fifteen inches, (which is also about fifteen inches from the dashboard), so as not to retard the starting movement of the ends 85, 86 of the safety belts 92, 93 (if we add longer safety belts 92, 93, we could pull them all the way to the dashboard 4 in one movement). After approximately a 5-second delay in the switch 11 attached to the motor 18 that moves the safety belts' ends 85,86 in the track 13, the safety belts 92, 93 start toward a non-restraining position 41. Then, as the ends 85, 86 of the safety belts 92 93 in the track 13, go into their non-restraining position 41, they flip a switch 42, which activates the motor 43 for the reel(s) 1 or retractor(s) 1 in the dashboard 4 for the small ropes) 2 or belt(s) 2 to immediately pull the area 3 of the safety belts 92, 93 near the middle of the seats retractor 37, 38 and bring that part 3 of the safety belts 92, 93 up very near to the middle of the dashboard 4. The vehicle occupants egress and ingress will then be greatly enhanced by the middle 3 of the safety belts 92, 93 being held next to the dashboard 4, out of the way.

An additional embodiment, though not shown, implements the features illustrated within FIG. 7 in for a rear seat. Consequently, the word “dashboard” 4 can be replaced with “backs of the front seats 48” or an addition thereto, for installing the reel(s) 1 or retractor(s) 1, to pull or release the small rope(s) 2 or small belt(s) 2 controlling the lap or shoulder belts 92, 93 being held out in front of the vehicle occupants, or, pulled out of the way, in this case, to the backs of the front seats 48. Also, we would need to install the motorized track 13 over and down the back door area, etc., and add safety belt 92, 93 retractors 37, 38, near the middle of the back seat. While these changes have not been illustrated, one skilled in the art of vehicle safety restraints could easily implement them.

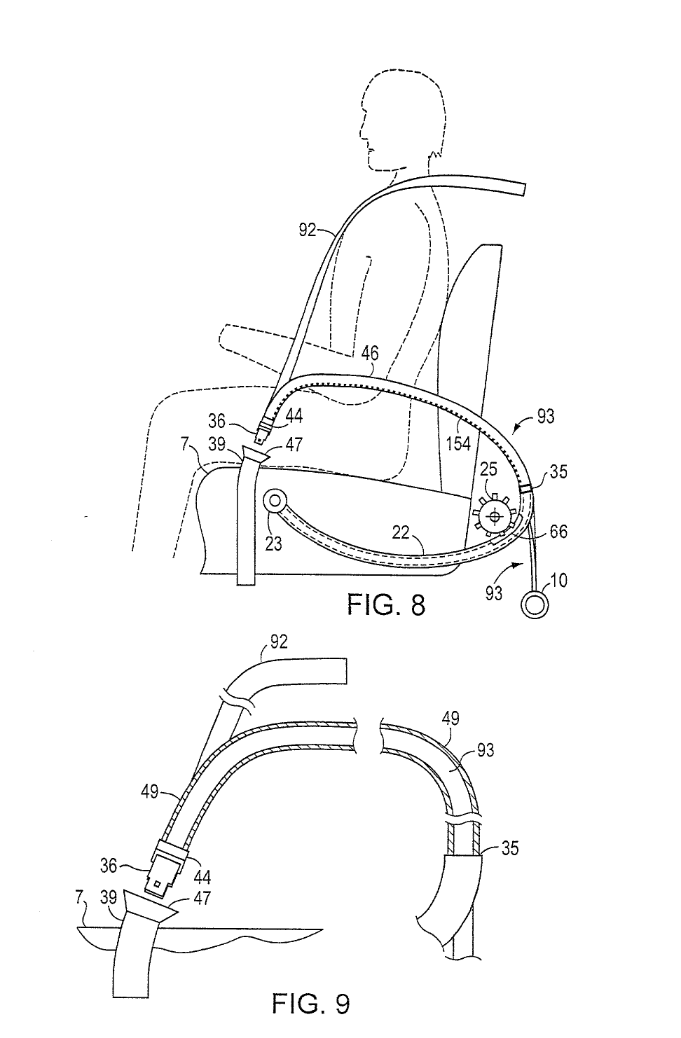

FIG. 8 illustrates another embodiment with a motor 25 underneath the vehicle seat 7 that controls the movement of a curved piece of metal 46, or hard plastic 46, with soft edges, that can hold the attachment 44 to the front end or catch 36 of the lap and shoulder 92, 93 belts. The curved piece 46 could have raised sides 49 and be opened on top 49 (see FIG. 9) so lap belt can lay there to go operative. These curved pieces 46 could be in telescopic form, like a car radio antenna, for ease of movement in limited space or, a solid curved metal (it could be other material made into a hollow sleeve), or plastic piece. When people get into a vehicle, before the ignition is turned on, they could still immediately fasten their lap and shoulder safety belts 92, 93, manually into a restraining position; approximately 66% of the population do now. Also, a switch 35 would be tripped when the occupant manually starts to move the safety belt's front end 36, up from the beside-the-seat location 35, and this would keep the under-the-seat motor 25 from operating.

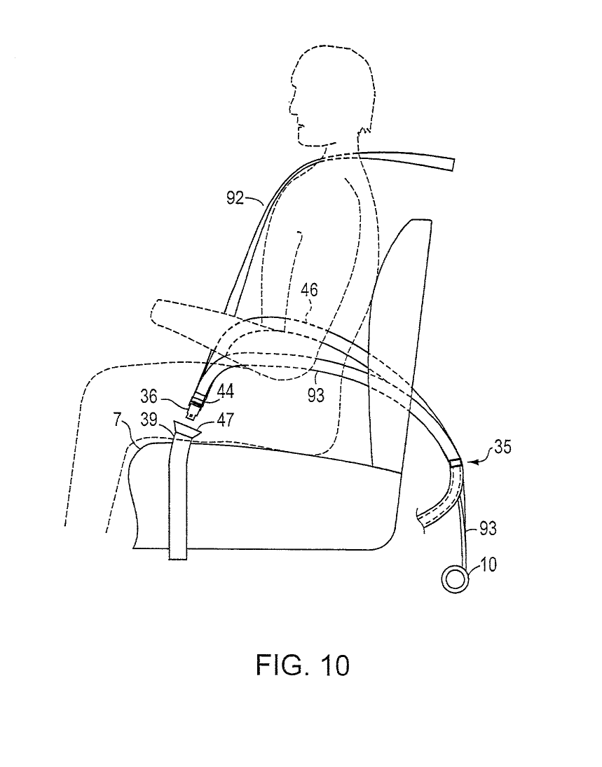

When the ignition is turned on, if the safety belts 92, 93 have not manually been put into the correct restraining position 39, then the following takes place: there is a motor 25 under the seat(s) 7 which begins to operate so that the front end of a curved piece of metal 46 or hard plastic 46, holds an attachment 44 to the end 36 or, to a catch on the end 36 of the lap 93 and shoulder 92 belts out in front of the vehicle occupants as it moves and carries the end 36, but the lap belt is moving below the curved piece (FIG. 10), as its front end moves into the normal receiving receptacle, between the two seats, where the safety belts 92, 93 will be in a normal restraining position 39. The receiving receptacle 39 can have several guiding edges and/or a large guiding opening 47, so it is easy to have the safety belts' end 36 go into the catch 39. Sometimes, the vehicle seat occupant might help guide the safety belts' end 36 into the restraining catch 39. When the safety belts' end 36 reaches the restraining catch 39 there is a switch 47 there, which is tripped, and the curved piece of metal 46 or hard plastic 46, will automatically return to its starting position 35. The vehicle occupant will always manually release the safety belts 92, 93 and return them to their starting position 35 when they leave the vehicle, just as they do now with manual safety belts.

We have a motor 25 underneath the vehicle seat 7 that controls the movement of curved metal or rigid plastic hollow sleeves 46 sheathed over the lap belt 93, that can hold an attachment to the front end 36 or catch 36 of the lap and shoulder belts 92, 93, and then move those safety belts 92, 93 to an operative position (FIG. 8), as described along with other actions in my previous paragraph. The difference from what is said in that paragraph is that the coil 10 or retractor 10, for the safety belts 92, 93, must be moved from the normal position near the end of the seat and the doorway 10 to a new position under the seat 23, and near the middle of the seat 23. Then, the curved metal or plastic sheathed sleeves 46, can go back to an inoperative position 22, without the safety belts' front end 36 portion, which remains in an operative position 39, but the sleeve is still around the lap belt near the coil or retractor.

Later, when the vehicle occupant wants to leave the vehicle and manually moves the safety belts ends 36 to an inoperative position 35, the safety belt 93 is pulled by the retractor reels 23 and it is pulled down inside the curved rigid smaller sleeve, which is inside an identically curved bigger sleeve (FIG. 8). This means when the safety belts 92, 93 are needed again, the front end of the curved rigid smaller sleeve holds an attachment to the end 36 or to a catch on the end of the lap and shoulder belts 92, 93, and, a turning piece from the motor 25 reaches into a slot 66 near the end of the outside bigger sleeve and moves the inside curved rigid smaller sleeve 46 by being in contact with the rim or edge of the smaller sleeve, where metal connectors 154, fit with the turning piece from the motor 25. This causes its front end to move the safety belts' front end 36 into the normal restraining position 39, in the middle of the vehicle seats.

If a passenger gets into a vehicle after the ignition has been turned on, and there is a person's weight in the seat and the door 14b flips a switch 78 when it is closed, the movement of the automatic safety belts 92, 93 will take place. This means that added passengers receive the automatic safety belts 92, 93, except for the fact that we add about a 30-second or more delay in the door switch 78 so that the new passenger(s) would have time to manually put the safety belts 92, 93 in a restraining position if they wanted to do that, and then prevent the motorized attachment 46 to the safety belts 92, 93 doing the job for them.

There may be a need to immediately turn on the ignition to start the vehicle motor to get the air conditioning or heater going. Therefore, the same 30-second or more delay switch 78 could be used initially, even for the first people to get into the vehicle. Then they would have more time to manually put their safety belts 92, 93 in a restraining position 39 if that's the way they would rather do it. Of course, this would also save wear and tear on the motor 25 under the seat 7.

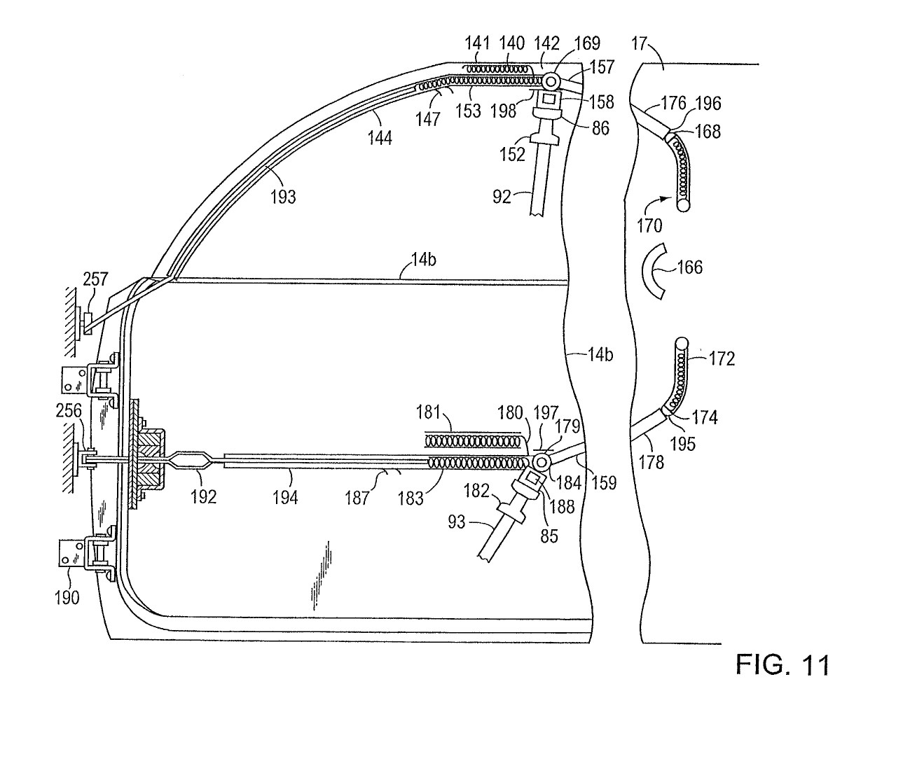

FIG. 11 illustrates another embodiment of the automated lap belt 93 and shoulder belt 92. These belts are attached to the vehicle door 14b. These belts are placed across the vehicles occupant's lap and shoulder when they enter the car and close the door 14b. Many people would get injured or killed when there is an accident and the door 14b flies open and takes away their lap belt and shoulder belt protection. It would make it much safer for the vehicle's occupants, if the lap and shoulder belts 92, 93 were fastened to the doorpost 17. For example, put guide rail grove 159 and 157 in the door 14b for the lap belt anchor plate 85 and shoulder belt anchor plate 86 so it can be moved to similar guide rail groves 176 and 178 in the doorpost 17 and into a catch point. In addition, aluminum is the preferred metal for guide rails.

The weight of an occupant in the vehicle seat 7 can activate the first solenoid. When the occupant of the vehicle closes the door 14b, there is a second solenoid activated but only if the first solenoid was already activated. This second solenoid activates a switch to open the catch points 197 and 198 like electronic door lock actuators on an automobile. Long pieces of metal 192 and 193 attached to the hinged side of the door 14b in such a manner (see 256, 257) can compress spring coils 183 and 153 inside the door 14b, when the door 14b is being closed.

Slots 187 and 147 in the sides of the tubes 194 and 144 for the curved front ends of rods 192 and 193 can provide a place to exit and take pressure off the springs 183 and 153, so they can be pulled back into their original position by the counter springs 181 and 141 which are attached to them at two points, 180 and 140. This is to happen after the rods 192 and 193 deliver the force needed by the springs 183 and 153 to move the lap belt anchor plate 85 and the shoulder belt anchor plate 86 in guide rail groves 159 and 157 to the (FIG. 11) catch points 174 and 168 on the doorpost 17 and thus, become operative.

When the vehicle occupant wants to get out of the vehicle, he can pull a release lever 166 on the doorpost 17. This releases the catch points 174 and 168, causing the activation of solenoids 195 and 196, which push the lap belt anchor plate 85 and the shoulder belt anchor plate 86 in the guide rail groves 178 and 176 back to their original position on the door 14b. Then the doorpost springs 172 and 170 attached to the protruding ends of the solenoids 195 and 196, would pull back the ends of the solenoids 195, 196, and they would return to the doorpost 17 out of the way of the door opening, to their original position. The door 14b can then be opened freely.

When the lap belt anchor plate 85 and the shoulder belt anchor plate 86 are moved back from the doorpost 17 to the guide rail groves 159 and 157, the opening of the door pulls back the rods 192 and 193, which in turn pull back the safety belts anchor plates 182 and 152 toward their starting position, several inches closer to the front of the door 14b. Both lap belt 93 and shoulder belt 92 each have an emergency release button 188 and 158. The benefit of this embodiment is that not only is it an automated safety device that saves lives and prevents injuries, but it is also very low cost for its installation and operation.

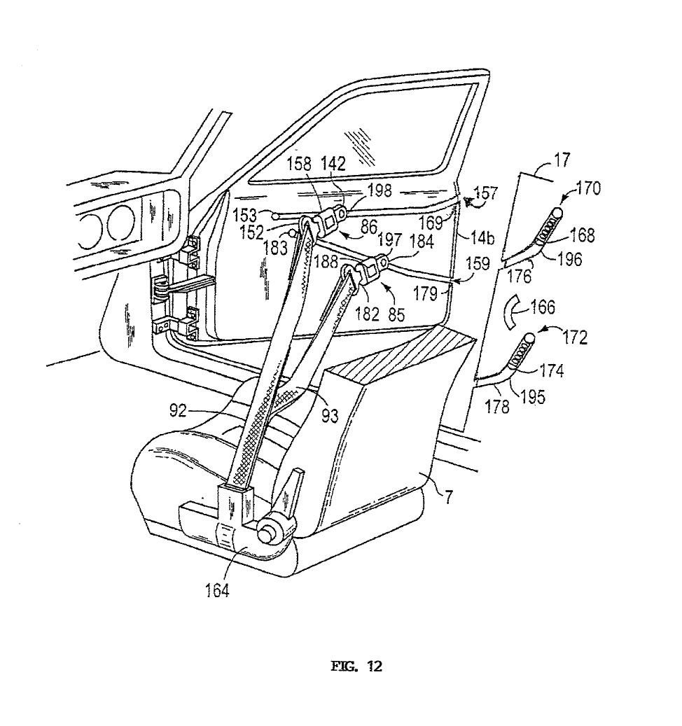

FIG. 12 illustrates another embodiment that automatically moves the lap belt 93 and the shoulder belt 92 by activating solenoid switches instead of springs. The weight of an occupant in the vehicle seat 7 can activate the first solenoid, which opens the catch points 179 and 169 on the door 14b. Second and third solenoids 184 and 142 only activate when the door 14b is closed and the first solenoid was activated. Then, the second and third solenoid 184 and 142, push the lap belt anchor plate 182 and the shoulder belt anchor plate 152 in guide rail groves 159 and 157 to catch points 174 and 168. Then the lap belt 93 and shoulder belt 92 are operative. The catch points 174 and 168 are only a few inches away on the doorpost 17. The second and third solenoids 184 and 142 pieces of protruding metal are pulled back to their starting position by the solenoids 183 and 153 in place beside them and attached to them.

When the vehicle occupant wants to get out of the vehicle, he pulls a release lever 166 on the doorpost 17, or another place, and this releases the catch points 174 and 168. This causes the activation of solenoids 195 and 196, which push the lap belt anchor plate 85 and the shoulder belt anchor plate 86 in the guide rail groves 178 and 176 back to their original position on the doorpost 17. Then, the doorpost springs 172 and 170 attached to the protruding ends of the solenoids 195 and 196, would pull back the ends of the solenoids 195 and 196, and they would return to the doorpost 17, out of the way of the door opening to their original position. The door can then be opened freely.

When the lap belt anchor plate 85 and the shoulder belt anchor plate 86 are moved back from the doorpost 17 to the guide rail groves 159 and 157, the solenoids in guide rail groves 159 and 157 would pull back the safety belts anchor plates 85 and 86 to their original starting position several inches closer to the front of the door, 14b. Both the lap belt 93 and shoulder belt 92 can include an emergency release button 188 and 158.

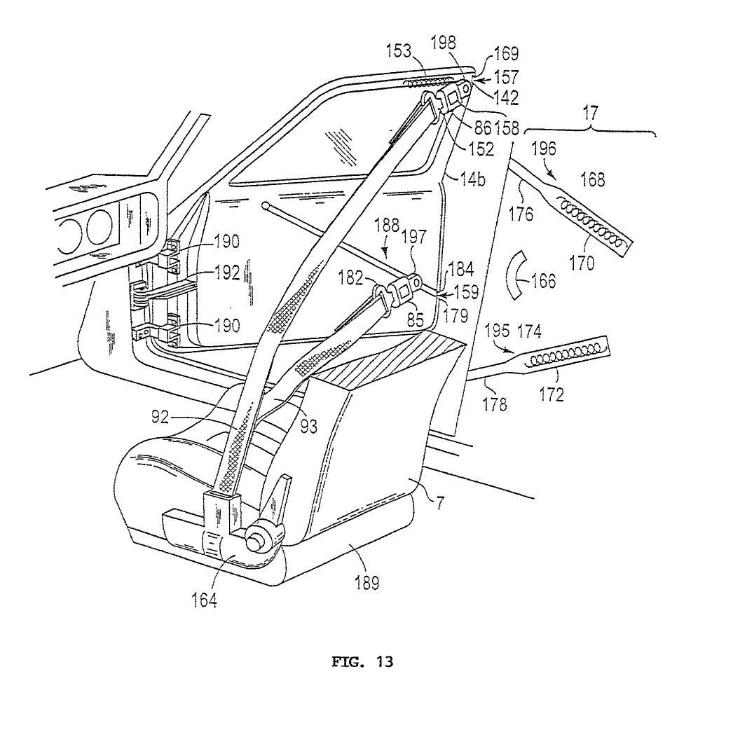

FIG. 13 illustrates an alternative embodiment to the system shown in FIG. 12. In FIG. 13, the shoulder belt connector 86 is moved by solenoids at the top of the door 14b. Similarly, the lap belt connector 85 is moved in an area a little higher on the door 14b than illustrated in FIG. 12. In another alternative embodiment, the drive belt 84 as shown on FIG. 1 may move the shoulder belt connector illustrated on FIG. 12. This movement occurs within the track 13 over the doorway 14a, and down the doorpost 17 of the vehicle to a catch point 98 for an operative position for the shoulder belt connector 86. Later, the shoulder belt connector 86 returns to its inoperative position 41 above the front of the doorway 14a.

An automatically closing seatbelt system according to the present invention enhances and increases passenger safety. The present invention employs technology that minimizes user annoyance by increasing the space between the user and seatbelt during a closing motion. By reducing user annoyance, the present system can increase the number of vehicle occupants that uses the system. In addition, the invention may provide both automatic shoulder and lap restraints. Consequently, the present invention may substantially improve the safety of vehicle passengers.

In view of the foregoing, it will be appreciated that present invention provides a system for automatically closing a seatbelt around a vehicle occupant. It should be understood that the foregoing relates only to the exemplary embodiments of the present invention, and that numerous changes may be made therein without departing from the spirit and scope of the invention as defined by the following claims.

The invention claimed is:

1. A safety belt system for automatically moving safety belts around an occupant in a seat of a vehicle, comprising:
first and second safety belts connected to an anchor at a first end and connected to a movable connector at a second end;
a track slidably constraining the movable connector;
an actuator operable when an occupant is in the seat of the vehicle for automatically sliding the movable connector along the track to cause an operative motion of the safety belts that puts the safety belt in a restraining position around the occupant;
a spacing device for maintaining a space between the safety belts and the occupant during an initial portion of the operative motion of the safety belts; and
wherein the spacing device is selected from the group consisting of:
(a) a reel spaced apart from the safety belts and a tether connecting the reel to a middle portion of the safety belts, wherein the reel and tether are jointly for varying the space between the seat belts and the occupant during the operative motion;
(b) a motor-driven curved sheath connected to the anchor of the first safety belt and operable, upon detection of the occupant in the seat of the vehicle, to automatically close the second safety belt around the occupant as the sheath positions the anchor of the first safety belt in the restraining position around the occupant; and
(c) a location of the track partially in a door of the vehicle adjacent to the seat, the track in the door being aligned with a track in a doorpost to allow the movable connector to slide from the track in the door into the track in the doorpost during the operative motion of the safety belt.

2. The system of claim 1 wherein the first safety belt is a shoulder belt and the second safety belt is a lap belt.

3. The system of claim 2 wherein the tether connects the reel to the shoulder belt and to the lap belt.

4. The system of claim 3 wherein the tether is a rope or a belt.

5. The system of claim 1 wherein the reel is located in a dashboard of the vehicle such that release of the tether during the operative motion moves the middle of the safety belts away from the dashboard and towards the occupant and retraction of the tether during an inoperative motion moves the middle of the safety belts away from the occupant and towards the dashboard.

6. The system of claim 5 further comprising a switch positioned in the track and in communication with the actuator so that in response to activation of the switch the reel releases the tether and the middle of the safety belts moves proximate the occupant for restraining the occupant in the seat.

7. The system of claim 6 further comprising a second switch positioned in the doorpost and operative for causing the reel to retract the tether and move the middle of the safety belts towards the dashboard.

8. The system of claim 7 wherein in response to retraction of the tether, the actuator moves the safety belts to a non-restraining position.

9. The system of claim 1 wherein the curved sheath comprises plastic or metal.

10. The system of claim 1 wherein the curved sheath extends under the seat at a second end.

11. The system of claim 1 further comprising a switch positioned proximate an end of the sheath so that, in response to activation of the switch, the safety belt system moves the safety belts to an inoperative position.

12. The system of claim 1 wherein the movable connector slides from the track in the door to the track in the doorpost in response to closing of the door.

13. The system of claim 12 further comprising a switch positioned in the doorpost and in communication with the actuator such that, in response to activation of the switch, the actuator puts the safety belt in the restraining position.

14. The system of claim 13 wherein deactivation of the switch puts the safety belt in an inoperative position.

15. The system of claim 12 further comprising a solenoid positioned in the doorpost and in communication with the actuator such that, in response to activation of the switch, the actuator puts the safety belt in the restraining position.

16. The system of claim 15 wherein deactivation of the solenoid puts the safety belt in an inoperative position.

17. The system of claim 1 wherein the track comprises aluminum.

18. The system of claim 2 wherein:
the track in the door comprises an upper door track for receiving an end of the shoulder belt proximate the movable connector and a lower door track for receiving an end of the lap belt proximate the movable connector; and
the track in the doorpost comprises an upper doorpost track for receiving the end of the shoulder belt during the operative motion and a lower doorpost track for receiving the end of the lap belt during the operative motion.

19. A safety belt system for automatically moving a safety belt around an occupant in a seat of a vehicle, comprising:
a safety belt connected to an anchor at a first end and connected to a movable connector at a second end;
a track slidably constraining the movable connector;
an actuator operable when an occupant is in the seat of the vehicle for automatically sliding the movable connector along the track to cause an operative motion of the safety belt that puts the safety belt in a restraining position around the occupant;
a spacing device for maintaining a space between the safety belt and the occupant during an initial portion of the operative motion of the safety belt; and
wherein the spacing device is selected from the group consisting of:
(a) a reel spaced apart from the safety belt and a tether connecting the reel to a middle portion of the safety belt, wherein the reel and tether are jointly for varying the space between the seat belt and the occupant during the operative motion;
(b) wherein the safety belt is a shoulder belt, a motor-driven curved sheath connected to the anchor of the shoulder belt and operable, upon detection of the occupant in the seat of the vehicle, to automatically close a lap belt around the occupant as it positions the anchor of the shoulder belt in the restraining position around the occupant; and
(c) a location of the track partially in a door of the vehicle adjacent to the seat, the track in the door being aligned with a track in a doorpost to allow the movable connector to slide from the track in the door into the track in the doorpost during the operative motion of the safety belt.
